(19) United States
(12) Patent Application Publication
(10) Pub. No.: US 2009/0040690 A1
(43) Pub. Date: Feb. 12, 2009

(54) Electrochemical capacitor

(75) Inventor: Naoshi Yasuda, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku (JP)

(21) Appl. No.: 11/631,363

(22) PCT Filed: Jun. 30, 2005
(86) PCT No.: PCT/JP2005/012129

§ 371 Date: Sep. 12, 2008

(30) Foreign Application Priority Data
Jun. 30, 2004 (JP) 2004-194036

(51) Int. Cl. H01G 9/025

(52) U.S. Cl. 361/525

(57) ABSTRACT

[Problems] To provide an electrochemical capacitor that is excellent in corrosion resistance and input/output characteristics and has a good storage capability.
[Means for solution] An electrochemical capacitor having a membrane-electrode-collector structure equipped with a pair of electrode layers containing a metal oxide and a proton-conducting polymer bonding agent, the electrode layer being connected to a metal foil collector, and a polymer electrolyte membrane sandwiched by both the electrode layers, wherein both or either of the proton-conducting polymer bonding agent and the polymer electrolyte membrane is(are) a sulfonic acid group-containing polyarylene containing a structural unit represented by general formula (A) and a structural unit represented by general formula (B).

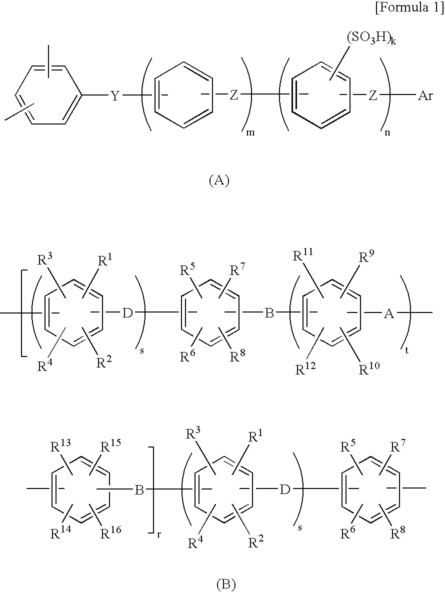

### TECHNICAL FIELD

The present invention relates to a novel electrochemical capacitor. More particularly, the present invention relates to a novel electrochemical capacitor (particularly, a redox capacitor) that is free from corrosion and has a low resistance and a high output density.

### BACKGROUND ART

Recently, large-capacity capacitor technologies have drawn attention as energy storage devices. A large-capacity capacitor mainly includes an electric double-layer capacitor, in which an electric double-layer generated at an electrode/electrolyte interface is utilized for storage and a redox capacitor, in which a metal oxide or a conducting polymer is used as an electrode and a redox reaction at the electrode surface (pseudo-electric double-layer capacitance) is involved in storage, and these are often collectively called an electrochemical capacitor.

Among them, a redox capacitor using a metal oxide has a high energy density; for example, it is known that a redox capacitor having an energy density as high as several tens of times of that of an electric double-layer capacitor can be produced by using ruthenium oxide hydrate as a metal oxide and an aqueous sulfuric acid as an electrolyte.

An electrochemical capacitor using a metal oxide as an electrode can provide a large capacity, while measures against corrosion are necessary if a concentrated aqueous solution of sulfuric acid is used as an electrolyte. In a conventionally well-known electric double-layer capacitor, activated carbon is used as an electrode and a concentrated aqueous solution of sulfuric acid is used as an electrolyte. In this case, a widely adopted method is the use of a composite material of rubber and conductive carbon as a collector. This type of composite material is effective as measures against corrosion; however, it has a higher resistance than metal and causes a resistance loss during charging and discharging, thereby resulting in a problem that a high input/output density is difficult to obtain. Meanwhile, a bonding agent is required in order to compose an electrode from a metal oxide serving as an electrode material. As a commonly used bonding agent, there are known Teflon (R), polyvinylidene fluoride, a rubber-based emulsion and the like. However, these materials have no proton conductivity, which is a major factor causing a resistance loss during charging and discharging as the above case. There has also been an attempt of using perfluoroalkylenesulfonic acid-type polymer (trade name: Nafion), which has proton conductivity, as the bonding agent. However, since such a perfluoro-type ionomer has poor binding ability for the electrode material, the electrode material is easily peeled off at the interface between metal or carbon composing a collector, causing difficulties in bonding.

Moreover, as an electrolyte layer, there is required a material that has proton conductivity high enough to substitute a concentrated aqueous solution of sulfuric acid, a good electrical junction with an electrode, and no possibility of corrosiveness.

### DISCLOSURE OF THE INVENTION

### Problems to be Solved by the Invention

An object of the present invention is to solve problems with respect to corrosion resistance and input/output characteristics as described above and to provide an electrochemical capacitor excellent in storage capability.

### Means to Solve the Problems

In order to solve the above problems, the present inventors have intensively studied on a capacitor usable in place of a capacitor using an aqueous solution of sulfuric acid, and as a result they have found that an electrochemical capacitor, in which a specific sulfonic acid group-containing polyarylene is used in a hydrated state as an electrolyte layer and the same polymer is used as a bonding agent for an electrode, can work as a high-capacity capacitor excellent in corrosion resistance and input/output characteristics.

That is, the configuration of the present invention is as follows.

(1) The electrochemical capacitor relating to the present invention is an electrochemical capacitor having a membrane-electrode-collector structure equipped with

a pair of electrode layers containing a metal oxide and a specific proton-conducting polymer bonding agent, the electrode layer being fixed to a metal foil, and

a polymer electrolyte membrane sandwiched by both the electrode layers, wherein

both or either of the proton-conducting polymer bonding agent and the polymer electrolyte membrane contain(s) a sulfonic acid group-containing polyarylene having a structural unit represented by general formula (A) below and a structural unit represented by general formula (B) below:

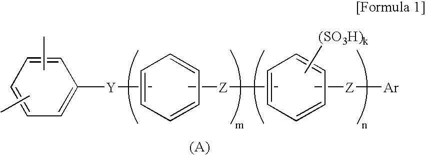

(wherein Y represents at least one kind of structure selected from the group consisting of —CO—, —SO₂—, —SO—, —CONH—, —COO—, —(CF₂)₁— (1 is an integer from 1 to 10) and —C(CF₃)₂—; Z represents a direct bond or at least one kind of structure selected from the group consisting of —(CH₂)₁— (1 is an integer from 1 to 10), —C(CH₃)₂—, —O— and —S—; Ar represents an aromatic group having a substituent represented by —SO₃H, —O(CH₂)_{P}SO₃H or —O(CF₂)ₚSO₃H; p represents an integer from 1 to 12; m represents an integer from 0 to 10; n represents an integer from 0 to 10; and k represents an integer from 1 to 4);

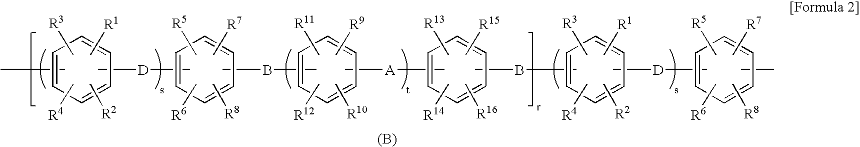

(wherein A and D represent independently a direct bond or at least one kind of structure selected from the group consisting of —CO—, —SO₂—, —SO—, —CONH—, —COO—, —(CF₂)₁— (1 is an integer from 1 to 10), —C(CH₂)₂— (1 is an integer from 1 to 10), —CR′₂—(R′ represents an aliphatic hydrocarbon group, an aromatic hydrocarbon group or a halogenated hydrocarbon group), a cyclohexylidene group, a fluorenylidene group, —O— and —S—; B is independently an oxygen atom or a sulfur atom; R¹ to R¹⁶ may be the same or different from each other and each represents at least one kind of atom or group selected from the group consisting of a hydrogen atom, a fluorine atom, an alkyl group, a haloalkyl group, which is partially or fully halogenated, an allyl group, an aryl group, a nitro group and a cyano group; s and t represent an integer from 0 to 4; and r represents 0 or an integer of 1 or more);
(2) The metal foil-made collector is preferably made of titanium or stainless steel having a thickness of 10 to 100 μm.
(3) In the metal oxide and the proton-conducting bonding agent, the amount of the proton-conducting bonding agent is preferably 2.5 parts by weight or more and 50 parts by weight or less with respect to 100 parts by weight of the metal oxide.
(4) The sulfonic acid group-containing polyarylene preferably contains sulfonic acid groups in an amount of 0.3 to 5 meq/g.

### EFFECTS OF THE INVENTION

The present invention can provide an electrochemical capacitor that has excellent corrosion resistance and output characteristics and exhibits good storage capability.

### BRIEF EXPLANATION OF DRAWINGS

FIG. 1 is a schematic cross-sectional view showing a configuration example of an electrode structure used for the electrochemical capacitor of the present invention.

### DESCRIPTION OF THE SYMBOLS

1 . . . Positive electrode
2 . . . Negative electrode
3 . . . Polymer electrolyte membrane
4 . . . Collector layer
5 . . . Electrode layer
8 . . . Case
9 . . . Corrugated spring
10 . . . Gasket

### BEST MODE FOR CARRYING OUT THE INVENTION

Hereinafter, the electrochemical capacitor relating to the present invention will be specifically explained.

At first there will be explained specifically the sulfonic acid group-containing polyarylene used in the membrane-electrode structure of the electrochemical capacitor relating to the present invention.

### (Sulfonic Acid Group-Containing Polyarylene)

First, the sulfonic acid group-containing polyarylene used in the present invention is explained specifically. The sulfonic acid group-containing polyarylene used in the present invention is characterized by comprising a structural unit having a sulfonic acid group(s) represented by general formula (A) below and a structural unit having no sulfonic acid group represented by general formula (B) below, and the sulfonic acid group-containing polyarylene is a polymer represented by general formula (C) below.

### <Sulfonic Acid Unit>

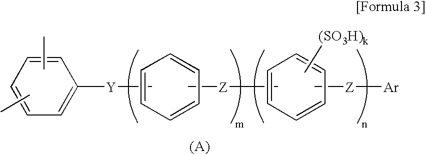

In general formula (A), Y represents at least one kind of structure selected from the group consisting of —CO—, —SO₂—, —SO—, —CONH—, —COO—, —(CF₂)₂— (1 is an integer from 1 to 10) and —C(CF₃)₂—. Among them, —CO— and —SO₂— are preferred.

Z represents a direct bond or at least one kind of structure selected from the group consisting of —(CH₂)₁— (1 is an integer from 1 to 10), —C(CH₃)₂—, —O— and —S—. Among them, a direct bond and —O— are preferred.

Ar represents an aromatic group having a substituent represented by —SO₃H, —O(CH₂)ₚSO₃H or —O(CF₂)ₚSO₃H (p represents an integer from 1 to 12).

The aromatic group is specifically exemplified by a phenyl group, a naphthyl group, an anthryl group, a phenanthryl group and the like. Among these groups, a phenyl group and a naphthyl group are preferred. The aromatic group is required to be substituted with at least one substituent represented by —SO₃H, —O(CH₂)ₚSO₃H or —O(CF₂)ₚSO₃H, and in the case of a naphthyl group, it is preferred to have two or more of the substituents.

m is an integer from 0 to 10, and preferably 0 to 2; n is an integer from 0 to 10, and preferably 0 to 2; and k represents an integer from 1 to 4.

A preferred combination of the values of m and n and the structures of Y, Z and Ar is exemplified as follow:

(1) a structure in which m is 0, n is 0, Y is —CO— and Ar is a phenyl group having —SO₃H as a substituent;
(2) a structure in which m is 1, n is 0, Y is —CO—, Z is —O— and Ar is a phenyl group having —SO₃H as a substituent;
(3) a structure in which m is 1, n is 1, k is 1, Y is —CO—, Z is —O— and Ar is a phenyl group having —SO₃H as a substituent;
(4) a structure in which m is 1, n is 0, Y is —CO— and Ar is a naphthyl group having two —SO₃H as substituents; and
(5) a structure in which m is 1, n is 0, Y is —CO—, Z is —O— and Ar is a phenyl group having —O(CH₂)₄SO₃H as a substituent.
<Hydrophobic. Unit>

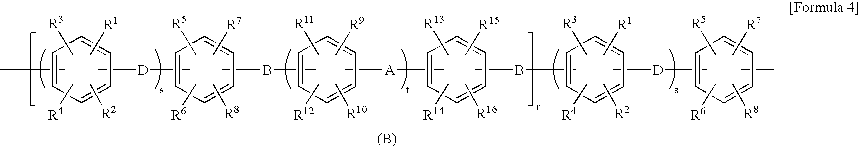

In general formula (B), A and D independently represent a direct bond or at least one kind of structure selected from the group consisting of —CO—, —SO₂—, —SO—, —CONH—, —COO—, —(CF₂)₁— (1 is an integer from 1 to 10), —C(CH₂)₁— (1 is an integer from 1 to 10), —CR′₂—(R′ represents an aliphatic hydrocarbon group, an aromatic hydrocarbon group or a halogenated hydrocarbon group), a cyclohexylidene group, a fluorenylidene group, —O— and —S—. As the specific example of R′, there are mentioned a methyl group, an ethyl group, a propyl group, an isopropyl group, a butyl group, an isobutyl group, a t-butyl group, an octyl group, a decyl group, an octadecyl group, a phenyl group, a trifluoromethyl group and the like. Among them, preferred are a direct bond or —CO—, —SO₂—, —CR′₂— (R′ represents an aliphatic hydrocarbon group, an aromatic hydrocarbon group and a halogenated hydrocarbon group), a cyclohexylidene group, a fluorenylidene group and —O—.

B is independently an oxygen atom or a sulfur atom, and an oxygen atom is preferred.

R¹ to R¹⁶ may be the same or different from each other and each represents at least one kind of atom or group selected from the group consisting of a hydrogen atom, a fluorine atom, an alkyl group, a haloalkyl group, which is partially or fully halogenated, an allyl group, an aryl group, a nitro group and a cyano group.

As the alkyl group, there are mentioned a methyl group, an ethyl group, a propyl group, a butyl group, an amyl group, a hexyl group, a cyclohexyl group, an octyl group and the like. As the haloalkyl group, there are mentioned a trifluoromethyl group, a pentafluoroethyl group, a perfluoropropyl group, a perfluorobutyl group, a perfluoropentyl group, a perfluorohexyl group and the like. The allyl group is exemplified by a propenyl group and the like, and the aryl group is exemplified by a phenyl group, a pentafluorophenyl group and the like.

s and t represent an integer from 0 to 4. r represents 0 or an integer of 1 or more, and the upper limit is typically 100 and preferably 1 to 80.

A preferred combination of the values of s and t and the structures of A, B, D, and R¹ to R¹⁶ includes (1) a structure in which s is 1, t is 1, A is —CR′₂— (R′ represents an aliphatic hydrocarbon group, an aromatic hydrocarbon group or a halogenated hydrocarbon group), a cyclohexylidene group or a fluorenylidene group, B is an oxygen atom, D is —CO— or —SO₂—, and R¹ to R¹⁶ each are a hydrogen atom or a fluorine atom; (2) a structure in which s is 1, t is 0, B is an oxygen atom, D is —CO— or —SO₂—, and R¹ to R¹⁶ each are a hydrogen atom or a fluorine atom; and (3) a structure in which s is 0, t is 1, A is —CR′₂— (R′ represents an aliphatic hydrocarbon group, an aromatic hydrocarbon group or a halogenated hydrocarbon group), a cyclohexylidene group or a fluorenylidene group, B is an oxygen atom, and R¹ to R¹⁶ each are a hydrogen atom, a fluorine atom, or a cyano group.

### <Structure of Polymer>

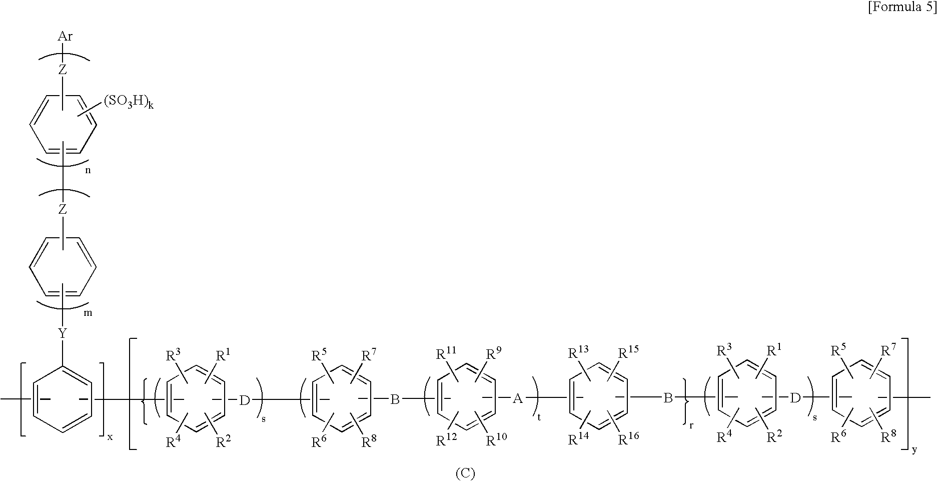

In general formula (C), A, B, D, Y, Z, Ar, k, m, n, r, s, t and R¹ to R¹⁶ have the same definition as A, B, D, Y, Z, Ar, k, m, n, r, s, t and R¹ to R¹⁶ in general formulae (A) and (B) above, respectively. x and y represent a molar ratio wherein x+y=100 mol %.

The sulfonic acid group-containing polyarylene used in the present invention contains the structural unit represented by formula (A), that is, the unit with subscript “x” at a ratio of 0.5 to 100 mol %, preferably 10 to 99.999 mol %, and the structural unit represented by formula (B), that is, the unit with subscript “y” at a ratio of 99.5 to 0 mol %, preferably 90 to 0.001 mol %.

### <Method for Producing the Polymer>

For producing the sulfonic acid group-containing polyarylene, for example, the following three methods, Method (A), Method (B) and Method (C), may be used.

Method (A): For example, by the method described in Japanese Patent Laid-open Publication No. 2004-137444, a monomer that has a sulfonate ester group and can turn the structural unit represented by general formula (A) is copolymerized with a monomer or oligomer that can turn the structural unit represented by general formula (B) to produce a polyarylene having a sulfonate ester group, and subsequently the sulfonate ester group is converted into a sulfonic acid group via de-esterification.

Method (B): For example, by the method described in Japanese Patent Laid-open Publication No. 2001-342241, a monomer that has a backbone represented by general formula (A) and has neither sulfonic acid group nor sulfonate ester group is copolymerized with a monomer or oligomer that can turn the structural unit represented by general formula (B) to produce a polymer, which is subsequently sulfonated using a sulfonating agent.

Method (C): When Ar in general formula (A) is an aromatic group having a substituent represented by —O(CH₂)ₚSO₃H or —O(CF₂)ₚSO₃H, for example, by the method described in Japanese Patent Laid-open Publication No. 2005-60625, a precursor monomer that can turn the structural unit represented by general formula (A) is copolymerized with a monomer or oligomer that can turn the structural unit represented by general formula (B) to prepare a polymer, and subsequently a sulfoalkyl group or a fluorinated sulfoalkyl group is introduced to the polymer.

A specific example of the monomer usable in Method (A), which has a sulfonate ester group and can turn the structural unit represented by general formula (A), includes the sulfonate esters described in Japanese Patent Laid-open Publication No. 2004-137444, Japanese Patent Laid-open Publication No. 2004-345997 and Japanese Patent Laid-open Publication No. 2004-346163.

A specific example of the monomer usable in Method (B), which has neither sulfonic acid ester nor sulfonate ester group and can turn the structural unit represented by general formula (A), includes the dihalides described in Japanese Patent Laid-open Publication No. 2001-342241 and Japanese Patent Laid-open Publication No. 2002-293889.

A specific example of the precursor monomer usable in Method (C), which can turn the structural unit represented by general formula (A), includes the dihalides described in Japanese Patent Laid-open Publication No. 2005-36125.

For example, the following compounds are exemplified.

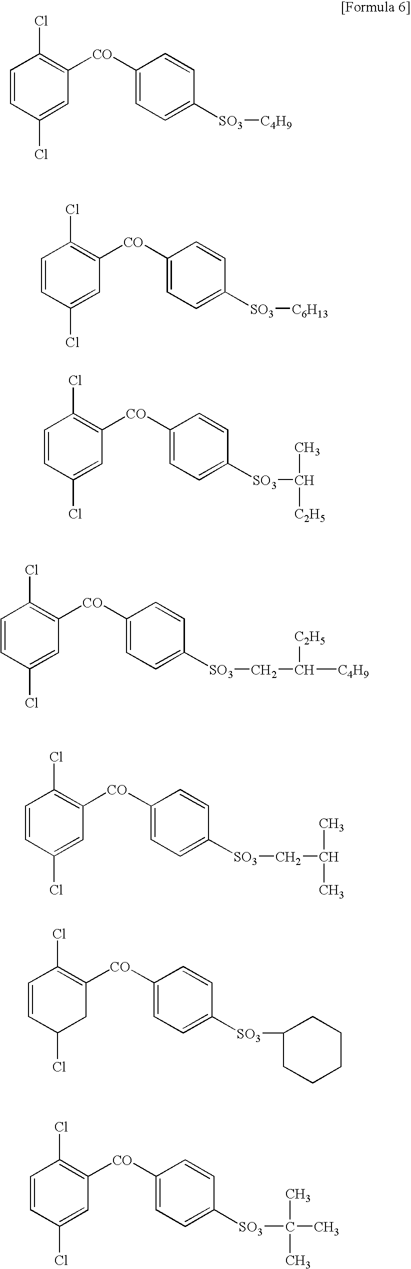

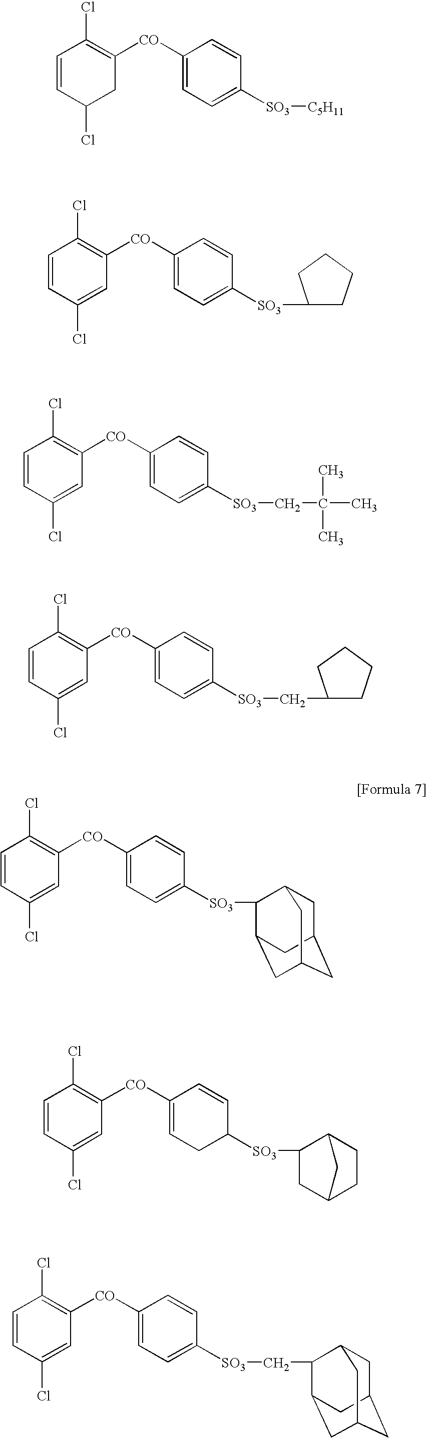

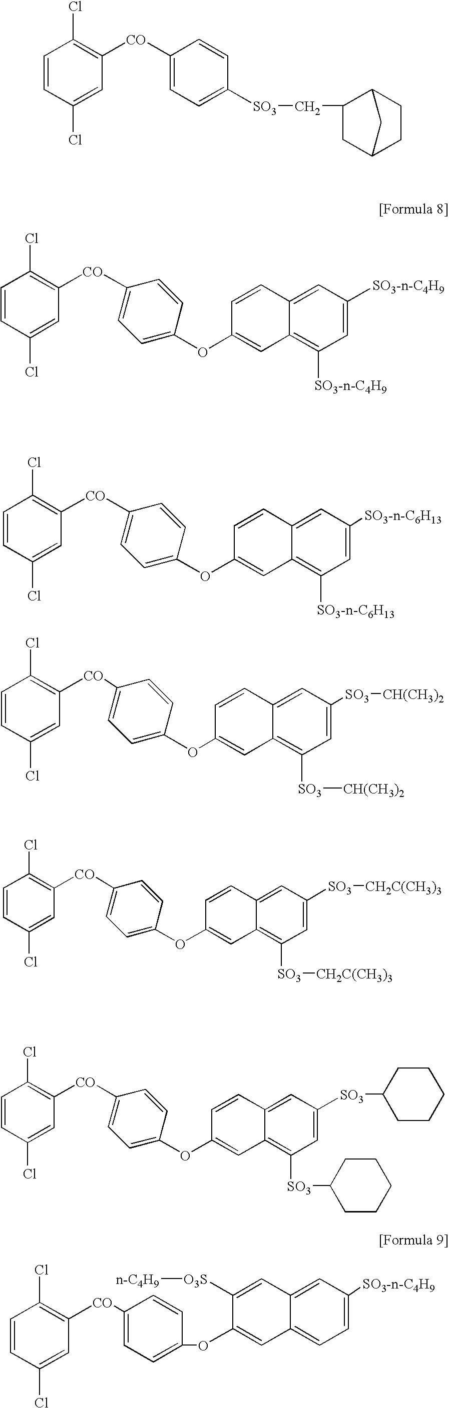

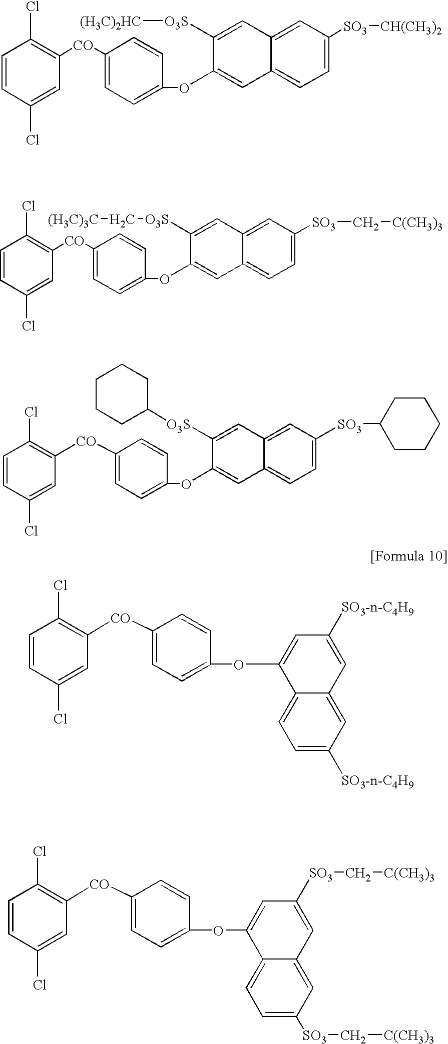

Further, as specific examples of the compound having neither sulfonic acid group nor sulfonate ester group, there may be mentioned the compounds below.

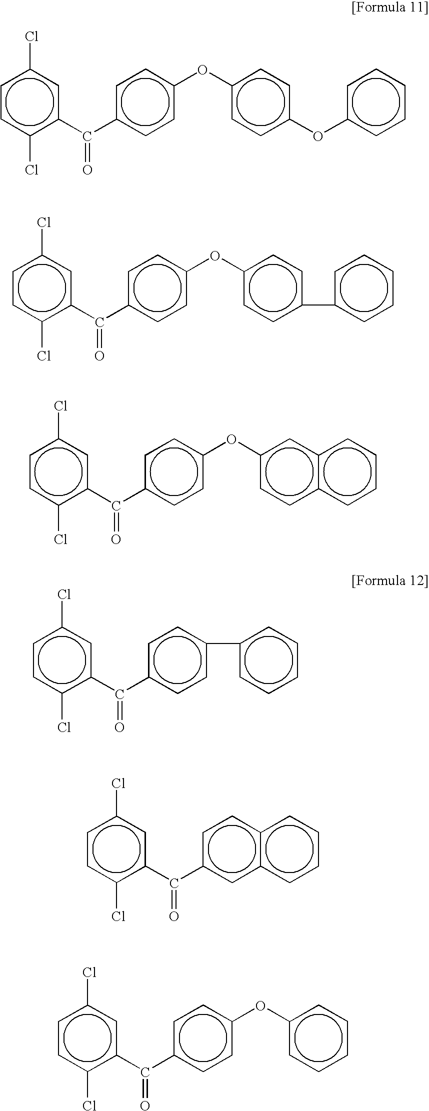

As specific examples of the monomer or oligomer usable in any of the methods, which can turn the structural unit represented by general formula (B),

when r is 0, there may be mentioned, for example, 4,4′-dichlorobenzophenone, 4,4′-dichlorobenzanilide, 2,2-bis(4-chlorophenyl)difluoromethane, 2,2-bis(4-chlorophenyl)-1,1,1,3,3,3-hexafluoropropane, 4-chlorophenyl 4-chlorobenzoate, bis(4-chlorophenyl) sulfoxide, bis(4-chlorophenyl) sulfone and 2,6-dichlorobenzonitrile; and compounds wherein the chlorine atoms in these compounds are replaced by bromine atoms or iodine atoms.

Examples wherein r is 1 include the compound described in Japanese Patent Laid-open Publication No. 2003-113136.

Examples wherein r is 2 or more include the compounds described in Japanese Patent Laid-open Publication No. 2004-137444, Japanese Patent Laid-open Publication No. 2004-244517, Japanese Patent Laid-open Publication No. 2004-346146, Japanese Patent Laid-open Publication No. 2005-112985, Japanese Patent Laid-open Publication No. 2003-348524, Japanese Patent Laid-open Publication No. 2004-211739 and Japanese Patent Laid-open Publication No. 2004-211740.

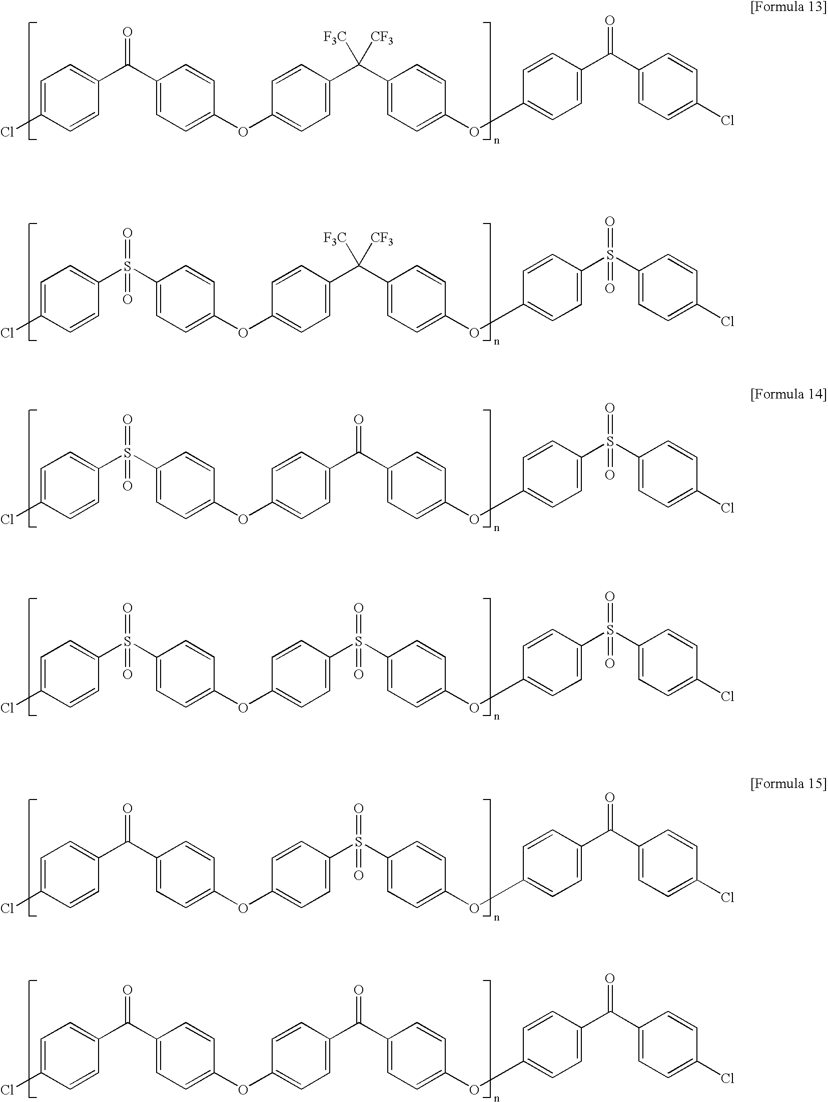

In order to obtain the sulfonic acid group-containing polyarylene, at first, it is required to obtain the precursor polyarylene by copolymerizing the monomer that can turn the structural unit represented by general formula (A) with the monomer or oligomer that can turn the structural unit represented by general formula (B). The copolymerization is performed in the presence of a catalyst, and the catalyst used here is a catalyst system containing a transition metal compound. The catalyst system contains, as essential components, (1) a transition metal salt and a compound that works as a ligand (hereinafter, referred to as “ligand component”), or a ligand-coordinated transition metal complex (including copper salt) and (2) a reducing agent. Moreover, a “salt” may be added to the catalyst system in order to increase the polymerization rate.

For the specific example of these catalyst components, the feed ratio of the components, the polymerization conditions such as reaction solvent, concentration, temperature and time, Japanese Patent Laid-open Publication No. 2001-342241 may be referred to.

The sulfonic acid group-containing polyarylene can be obtained by converting the precursor polyarylene into a polyarylene having sulfonic acid groups. The method for the conversion includes the following three methods:

Method (A): A method of de-esterifying the precursor polyarylene having sulfonate ester groups by the method described in Japanese Patent Laid-open Publication No. 2004-137444;

Method (B): A method of sulfonating the precursor polyarylene by the method described in Japanese Patent Laid-open Publication No. 2001-342241; and

Method (C): A method of introducing sulfoalkyl groups into the precursor polyarylene by the method described in Japanese Patent Laid-open Publication No. 2005-60625.

The sulfonic acid group-containing polyarylene represented by general formula (C) produced by the method described above typically has an ion-exchange capacity of 0.3 to 5 meq/g, preferably 0.5 to 3 meq/g, and more preferably 0.8 to 2.8 meq/g. If the ion-exchange capacity is less than 0.3 meq/g, the proton conductivity is low and the discharge capability is low. On the other hand, if the ion-exchange capacity exceeds 5 meq/g, the water resistance may be largely reduced.

The ion-exchange capacity can be adjusted, for example, by varying the types, feed ratio and combination of the precursor monomer that can turn the structural unit represented by general formula (A) and the monomer or oligomer that can turn the structural unit represented by general formula (B).

The molecular weight of the sulfonic acid group-containing polyarylene thus obtained is 10000 to 1000000, preferably 20000 to 800000 in terms of polystyrene-equivalent weight average molecular weight as determined by gel permeation chromatography (GPC).

### (Electrochemical Capacitor)

The electrochemical capacitor relating to the present invention has a membrane-electrode-collector structure equipped with

a pair of electrode layers that contain a metal oxide and a proton-conducting polymer bonding agent, the electrode layer being fixed to a metal foil collector, and

a polymer electrolyte membrane sandwiched by both the electrode layers, wherein

the above-described sulfonic acid group-containing polyarylene is contained as both or either of the proton-conducting polymer bonding agent and the polymer electrolyte membrane.

Hereinafter, specific explanation will be given on the electrode used in the membrane-electrode-collector structure of the electrochemical capacitor relating to the present invention.

The electrode used in the present invention contains a metal oxide and a proton-conducting polymer bonding agent.

As the metal oxide used in the present invention, either a noble metal oxide or a non-noble metal oxide may be used if it is a metal oxide used for redox capacitors.

As the noble metal oxide, there may be mentioned RuO₂, IrO₂, a composite material of RuO₂ and IrO₂, a composite material of RuO₂ and TiO₂, a composite material of RuO₂ and ZrO₂, a composite material of RuO₂ and Nb₂O₅, a composite material of RuO₂ and SnO₂, a composite oxide of ruthenium and vanadium, a composite oxide of ruthenium and molybdenum, a composite oxide of ruthenium and calcium, and the like.

As the non-noble metal oxide, there may be mentioned NiO, WO₃, CO₃O₄, MoO₃, TiO₂, Fe₃O₄ and the like.

Further, the metal oxide may be a hydrate, and specifically includes RuO₂.nH₂O, (Ru+Ir)Oₓ.nH₂O, Ru_{(1-y)}Cr_{y}O₂.nH₂O, MnO₂.nH₂O, V₂O₅. nH₂O, NiO.nH₂O and the like.

Of these metal oxides, a non-crystalline hydrated metal oxide is preferred because high capacity is attained, and non-crystalline RuO₂.nH₂O and (Ru+Ir)Oₓ.nH₂O are particularly preferred.

In order to increase the electron conductivity of metal oxide, a conductive agent such as carbon black and graphite may be added together.

A metal oxide in a particulate state is typically used and a particulate of 0.01 to 5 μm in size is suitably used.

As the proton-conducting polymer bonding agent, there is used the above-described sulfonic acid group-containing polyarylene used for the electrolyte layer in the present invention.

By using the proton-conducting polymer bonding agent, the hydrogen ion exchange reaction proceeds smoothly at the electrode/electrolyte interface, and excellent storage characteristics are obtained.

Further, since the polymer bonding agent used in the present invention can assure good adhesion between electrode particles even if added to the electrode material in a small amount, high electron conductivity can be achieved together with high proton conductivity, and therefore good charge/discharge capability with a high energy density can be provided.

Moreover, when the polymer bonding agent of the present invention is used, the resistance loss at the collector/electrode interface can be minimized because good adhesion to the metal foil composing the collector can be assured.

The amount of the polymer bonding agent contained in the electrode is desirably in the range of 2.5 to 50% by weight, and preferably 5 to 25% by weight with respect to the amount of the metal oxide. If the amount is less than the lower limit of the above-described range, the adhesion to the collector metal foil may be decreased, while if the mount exceeds the upper limit, the electron conductivity between electrode particles may be reduced, resulting in deterioration in charge/discharge characteristics.

The molecular weight of the bonding agent of the present invention is preferably 10000 or more and 1000000 or less, and more preferably 10000 to 200000 as represented by weight average molecular weight.

The metal foil used for the collector of the present invention includes titanium, nickel, stainless steel, niobium and the like. Among them, in terms of cycling characteristics and stability including temporal variation, titanium, stainless steel and niobium are preferred, and considering workability in forming a foil, cost and the like, titanium and stainless steel are particularly preferred.

In the present invention, a metal foil having a thickness of approximately 5 to 100 μm can be used.

The electrode-collector assembly can be produced as follows: a polymer bonding agent and metal oxide particles are dispersed or dissolved in a volatile solvent to make a paste, the paste was applied to a surface of a highly releasable substrate, for example, a polyester film, and dried, the substrate was peeled off, the resultant film was laminated on a collector foil, and these materials were bonded by hot pressing. Alternatively, the electrode-collector assembly can also be produced by directly applying the paste to the surface of a collector followed by drying.

The compression treatment of the electrode may be carried out by further applying hot rolling or the like to the obtained electrode-collector assembly.

In the present invention, there is used a structure composed of the electrode-collector assembly and a polymer electrolyte membrane.

The polymer electrolyte membrane is produced as follows: the above-described sulfonic acid group-containing polyarylene is dissolved in a solvent to make a solution, an additive is optionally added and mixed with or dissolved in the solution, and the resultant solution is formed into a film by developing the solution on a substrate by casting to form into a film (casting method) or the like.

The substrate is not particularly limited if it is a substrate used for a conventional solution casting method, for example, a substrate made of plastics or metal may be used, and preferably, for example, a substrate made of a thermoplastic resin such as a polyethylene terephthalate (PET) film is used.

The solvent includes, specifically, an aprotic polar solvent such as N-methyl-2-pyrrolidone, N,N-dimethylformamide, γ-butyrolactone, N,N-dimethylacetamide, dimethyl sulfoxide, dimethylurea and dimethylimidazolidinone (DMI), and N-methyl-2-pyrrolidone is particularly preferred from the aspect of the solubility and the viscosity of solution. The aprotic polar solvents may be used alone or in combination of two or more.

Further, as the solvent dissolving the sulfonic acid group-containing polyarylene, a mixture of the aprotic polar solvent and an alcohol may be used. The alcohol includes, specifically, methanol, ethanol, propyl alcohol, isopropyl alcohol, sec-butyl alcohol, tert-butyl alcohol and the like, and methanol is particularly preferred owing to the effect of decreasing the viscosity of solution in a wide composition range. The alcohols may be used alone or in combination of two or more.

In producing a polymer electrolyte membrane, there may be also used an inorganic acid such as sulfuric acid or phosphoric acid, an organic acid including a carboxylic acid, an appropriate amount of water or the like together with the polymer containing acidic ion-conducting moieties and the solvent.

Further, an additive that interacts with the acidic ion-conducting moieties (sulfonic acid groups) in the polymer may be also used in addition to the polymer containing acidic ion-conducting moieties, the solvent and the organic acid described above. As the additive to be added to the solution containing the sulfonic acid group-containing polyarylene, there may be selected an organic or inorganic compound that is capable of an acid-base interaction, that is, salt formation with the sulfonic acid group-containing polyarylene and is soluble in water or a polar solvent.

The solution prepared by dissolving the sulfonic acid group-containing polyarylene in a solvent may be directly applied to an electrode surface and dried to form a polymer electrolyte membrane.

The thickness of the polymer electrolyte membrane is selected according to the capacity, size and output of the capacitor, and typically approximately 15 to 150 μm.

When the obtained polymer electrolyte membrane and the electrode-collector assembly are used for a capacitor, the polymer electrolyte membrane is sandwiched by a pair of the electrode-collector assemblies, and the interfaces between the electrolyte membrane and the electrode are bonded by hot pressing or hot rolling to form a membrane-electrode-collector structure.

The obtained membrane-electrode-collector structure is immersed in water to hydrate. The hydrated structure is housed in a given capacitor can to use as an electrochemical capacitor. The membrane-electrode structure may be formed as a stack having two or more layers or may be housed in a rolled shape, if necessary. When two or more layers are stacked or the rolled structure is used, the capacity can be increased. Further, in forming such a stack, there may be adopted a configuration in which, instead of providing two adjacent collectors, electrodes are formed on the front and back sides of one sheet of collector so that the electrodes can share the collector.

In forming the structure, the electrolyte membrane and the electrode-collector assemblies may be hydrated in advance followed by bonding the electrolyte membrane/electrode interfaces by hot pressing or the like to form the membrane-electrode-collector structure.

The above-described polyarylene may be contained in both the polymer bonding agent and the polymer electrolyte membrane as mentioned above, or may be contained in either thereof.

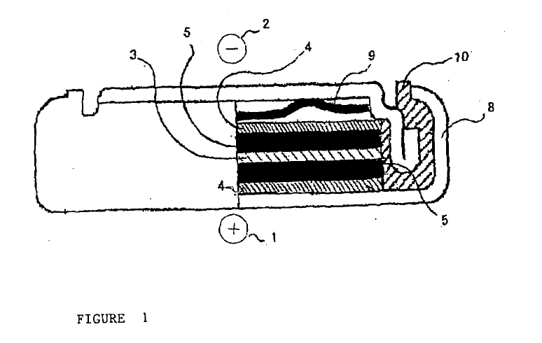

Hereinafter, the electrochemical capacitor relating to the present invention will be explained with reference to Drawing. FIG. 1 is a schematic cross-sectional view showing a configuration example of a membrane-electrode-collector structure used in the electrochemical capacitor.

The electrochemical capacitor is equipped with a membrane-electrode-collector structure, for example, configured as shown in FIG. 1.

The membrane-electrode-collector structure has a polymer electrolyte membrane 3 between a positive electrode 1 and a negative electrode 2, and both the positive electrode 1 and the negative electrode 2 are equipped with a collector layer 4 and an electrode layer 5 formed on the collector layer 4 and contact with the polymer electrolyte membrane 3 at the side of the electrode layer 5. The polymer electrolyte membrane 3 is composed of the above-described sulfonic acid group-containing polyarylene membrane, and the electrode layer 5 contains the above-described metal oxide and a proton-conducting polymer as a bonding agent.

The collector layer 4 is made of a metal foil. In conventional electrochemical capacitors, it was difficult to use a metal foil because a solution of sulfuric acid was used as an electrolytic solution, which possibly causes corrosion. However, in the present invention, because there is no possibility of the above mentioned corrosion caused by the specific aqueous sulfuric acid, it is not required to use a specific and low resistant material such as a composite material of conductive carbon and rubber, and a metal foil such as SUS and nickel may be used.

That is, junction between the electrode layer 5 and the collector 4 is formed by preparing an electrode paste by homogeneously mixing metal oxide powders and a proton-conducting polymer serving as a bonding agent, and then either applying the paste directly to the collector 4 or applying the paste, for example, to a polyester film followed by hot pressing of the dried electrode with the collector metal foil, as mentioned above. Thus, the electrode-collector assembly is formed.

Subsequently, the structure is formed by bonding the electrode-electrolyte membrane interfaces by hot pressing in a state where the polymer electrolyte membrane 3 is sandwiched by the positive electrode 1 and the negative electrode 2, which are electrode-collector assemblies. The structure is hydrated, set in a sealing case 8 serving as a package case, fixed with a corrugated spring 9 as needed, and sealed to form an electrochemical capacitor.

SUS may be used as the material of the sealing can because it is not required to consider corrosion by sulfuric acid.

For the package case, it is possible to adopt various shapes such as a cylindrical shape, a square shape in addition to a button shape shown in FIG. 1, depending on the shape of a capacitor.

### EXAMPLES

Hereinafter, the present invention will be explained more specifically based on examples, but the present invention is not limited to these Examples.

In Examples, the sulfonic acid equivalent weight, molecular weight and proton conductivity are determined as follows.

1. Sulfonic Acid Equivalent Weight

The sulfonic acid group-containing polymer obtained was sufficiently washed with water to remove acid remaining unbound to the polymer until the washing became neutral, and then dried. A predetermined amount of the polymer was weighed and titrated with a standardized NaOH solution using phenolphthalein dissolved in THF/water mixed solvent as an indicator, and the sulfonic acid equivalent weight was determined from the point of neutralization.

2. Determination of Molecular Weight

The weight average molecular weight of a polyarylene having no sulfonic acid group was determined as the polystyrene-equivalent molecular weight by GPC using tetrahydrofuran (THF) as a solvent. The molecular weight of a sulfonic acid group-containing polyarylene was determined as the polystyrene-equivalent molecular weight by GPC using N-methyl-2-pyrrolidone (NMP), to which lithium bromide and phosphoric acid are added as eluting agents, as an eluent.

3. Determination of Proton Conductivity

Platinum wires (diameter 0.5 mm) were pressed onto the surface of a polymer electrolyte membrane specimen in a strip shape having a width of 5 mm, the specimen was placed in a thermo-hygrostat, and the alternating current impedance between the platinum wires was measured to determine the alternating current resistance. Specifically, the impedance for alternating current of 10 kHz was measured at 25° C. and 60° C. under a relative humidity of 80%.

A chemical impedance measurement system manufactured by NF Corporation was used as the resistance analyzer. A JW241 thermo-hygrostat manufactured by Yamato Scientific Co., Ltd. was used. Five platinum wires were pressed onto the specimen at an interval of 5 mm, and the alternating current resistance was measured for different inter-wire distances between 5 to 20 mm. The specific resistance of the membrane was calculated from the slope of resistance versus inter-wire distance, the alternating current impedance was calculated from the reciprocal of specific resistance, and the proton conductivity was calculated from the impedance.

Specific resistance R(Ω·cm)=0.5(cm)×Membrane thickness (cm)×Resistance−distance slope (Ω/cm)

### Synthesis Example 1

### Preparation of Oligomer

A 1-L three-necked flask equipped with a stirrer, a thermometer, a cooling tube, a Dean-Stark tube and a nitrogen inlet with a three-way cock, was charged with 67.3 g (0.20 mol) of 2,2-bis(4-hydroxyphenyl)-1,1,1,3,3,3-hexafluoropropane (bisphenol AF), 60.3 g (0.24 mol) of 4,4′-dichlorobenzophenone (4,4′-DCBP), 71.9 g (0.52 mol) of potassium carbonate, 300 mL of N,N-dimethylacetamide(DMAc) and 150 mL of toluene, and the mixture was heated at 130° C. with stirring in an atmosphere of nitrogen in an oil bath. When the reaction was carried out while the water generated from the reaction was removed out of the system through the Dean-Stark tube by azeotropic distillation with toluene, generation of water almost ceased in approximately 3 hr. The reaction temperature was gradually raised from 130 to 150° C., during which most of the toluene was removed, and the reaction was continued at 150° C. for 10 hr. To the reaction solution was added 10.0 g (0.040 mol) of 4,4′-DCBP, and the reaction was carried out for another 5 hr. The resultant reaction solution was left to cool and filtered to remove precipitated inorganic compounds, which were generated as byproducts, and the filtrate was poured into 4 L of methanol. The precipitated product was collected by filtration and dried. The dried precipitate was dissolved in 300 mL of tetrahydrofuran, and this solution was poured into 4 L of methanol for reprecipitation to obtain 95 g of the desired compound (85% yield).

The obtained polymer had a polystyrene-equivalent weight average molecular weight of 11,200 as determined by GPC (solvent:THF). The obtained polymer was soluble in THF, NMP, DMAc, sulfolane and the like, and had a Tg of 110° C. and a thermal decomposition point of 498° C.

The obtained compound was found to be an oligomer represented by formula (I) (hereinafter referred to as “BCPAF oligomer”).

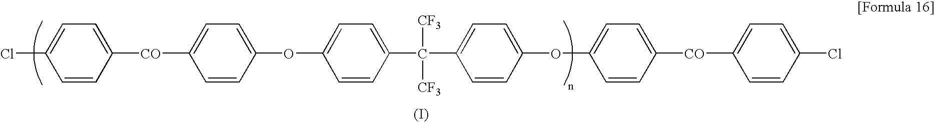

### Synthesis Example 2

### Preparation of Polyarylene Copolymer Having a Neopentyl Group as a Protective Group (PolyAB-SO₃neo-Pe)

A 500-mL three-necked flask equipped with a stirrer, a thermometer, a cooling tube, a Dean-Stark tube and a nitrogen inlet with a three-way cock, was charged with 39.58 g (98.64 mmol) of neopentyl 4-[4-(2,5-dichlorobenzoyl)phenoxy]benzenesulfonate (A-SO₃neo-Pe), 15.23 g (0.136 mmol) of BCPAF oligomer (Mn=11200), 1.67 g (0.26 mmol) of Ni(PPh₃)₂Cl₂, 10.49 g (4.00 mmol) of PPh₃, 0.45 g (0.30 mmol) of NaI, 15.69 g (24.0 mmol) of zinc powder and 129 mL of dried NMP in an atmosphere of nitrogen, and the reaction system was heated with stirring (ultimately heated to 75° C.) to allow to react for 3 hr. The polymerization solution was diluted with 250 mL of THF and stirred for 30 min and then filtered using Celite as a filter aid. The filtrate was poured into a large excess amount of methanol (1500 mL) to solidify the product. The solid was collected by filtration, air-dried, and redissolved in THF/NMP (200/300 mL, respectively) followed by precipitating with a large excess amount of methanol (1500 mL). After air-drying, the precipitate was dried with heating to obtain 47.0 g (92% yield) of the desired yellow fibrous copolymer (PolyAB-SO₃neo-Pe), composed of a sulfonic acid derivative protected by a neopentyl group. The molecular weights as determined by GPC were 47,600 as Mn and 159,000 as Mw.

In 60 mL of NMP was dissolved 5.1 g of PolyAB-SO₃neo-Pe thus obtained and the solution was heated to 90° C. To the reaction system was added a mixture of 50 mL of methanol and 8 mL of concentrated hydrochloric acid at a time. The reaction was carried out under mild reflux conditions for 10 hr while maintaining a suspension state. A distillation apparatus was set and excess methanol was distilled off to obtain a pale green transparent solution. This solution was poured into a large amount of water/methanol (1:1, in weight ratio) to solidify the polymer, and the polymer was washed with ion-exchanged water until the pH of the washing became 6 or more. From the IR spectrum and the quantitative analysis of ion exchange capacity of the polymer thus obtained, it was found that the sulfonate ester group (—SO₃R) was quantitatively converted into a sulfonic acid group (—SO₃H).

The molecular weights of the obtained sulfonic acid group-containing polyarylene copolymer, as determined by GPC, were 53,200 as Mn and 185,000 as Mw, and the sulfonic acid equivalent weight was 2.2 meq/g.

### Synthesis Example 3

### Synthesis of Hydrophobic Unit

Into a 1-L three-necked flask equipped with a stirrer, a thermometer, a Dean-stark tube, a nitrogen inlet tube and a cooling tube were weighed 48.8 g (284 mmol) of 2,6-dichlorobenzonitrile, 89.5 g (266 mmol) of 2,2-bis(4-hydroxyphenyl)-1,1,1,3,3,3-hexafluoropropane and 47.8 g (346 mmol) of potassium carbonate. After substitution with nitrogen gas, 346 mL of sulfolane and 173 ml, of toluene were added and the resultant mixture was stirred. The reaction solution was heated under reflux at 150° C. in an oil bath. The water generated by the reaction was trapped into the Dean-Stark tube. After 3 hr, when the generation of water almost ceased, toluene was removed out of the system through the Dean-Stark tube. The reaction temperature was gradually raised to 200° C., stirring was continued for 3 hr, subsequently 9.2 g (53 mmol) of 2,6-dichlorobenzonitrile was added, and the reaction was continued for additional 5 hr.

The reaction solution was left to cool and diluted with 100 mL of toluene. Inorganic salts insoluble in the reaction solution were filtered off, and the filtrate was poured into 2 L of methanol to precipitate the product. The precipitated product was filtered and dried, and then dissolved in 250 mL of tetrahydrofuran. The resultant solution was poured into 2 L of methanol for reprecipitation. The precipitated white powders were filtered and dried to obtain 109 g of the desired product. The number average molecular weight (Mn) was 9,500 as determined by GPC.

The obtained compound was confirmed as an oligomer represented by formula (I).

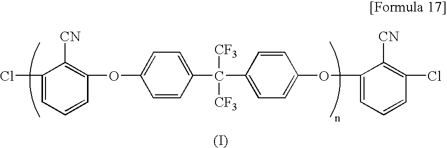

### Synthesis Example 4

### Synthesis of Sulfonated Polymer

Into a 1-L three-necked flask equipped with a stirrer, a thermometer and a nitrogen inlet tube were weighed 135.2 g (337 mmol) of neopentyl

3-(2,5-dichlorobenzoyl)benzenesulfonate, 48.7 g (5.1 mmol) of the hydrophobic unit having an Mn of 9500 obtained in Synthesis Example 3, 6.71 g (10.3 mmol) of bis(triphenylphosphine) nickel dichloride, 1.54 g (10.3 mmol) of sodium iodide, 35.9 g (137 mmol) of triphenylphosphine and 53.7 g (821 mmol) of zinc, and the air in the flask was replaced by dry nitrogen.

To the flask was added 430 mL of N,N-dimethylacetamide (DMAc) and stirring was continued for 3 hr while the reaction temperature was maintained at 80° C., and thereafter the mixture was diluted by adding 730 mL of DMAc, followed by filtering off insoluble materials.

The obtained solution was placed in a 2-L three-necked flask equipped with a stirrer, a thermometer and a nitrogen inlet tube, and heated to 115° C. with stirring, followed by adding 44 g (506 mmol) of lithium bromide. After stirring 7 hr, the mixture was poured into 5 L of acetone to precipitate the product. The precipitate was washed sequentially with 1N hydrochloric acid and purified water and dried to obtain 122 g of the desired polymer. The obtained polymer had a weight average molecular weight (Mw) of 135,000. It was presumed that the obtained polymer was a sulfonated polymer represented by formula (II).

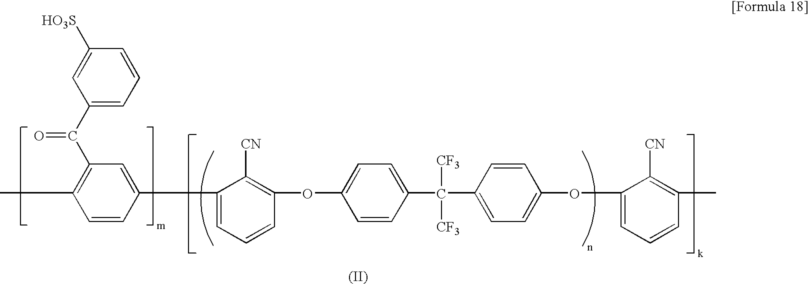

An 8-wt % NMP solution of the obtained sulfonated polymer was cast on a glass plate to form a film, which was air-dried and vacuum-dried to obtain a film having a dried thickness of 40 μm. The evaluation results of the obtained film are shown in Table 1.

### Synthesis Example 5

### Synthesis of Sulfonated Polymer

Into a 1-L three-necked flask equipped with a stirrer, a thermometer and a nitrogen inlet tube were weighed 135.2 g (337 mmol) of neopentyl

3-(2,5-dichlorobenzoyl)benzenesulfonate, 48.7 g (5.1 mmol) of the hydrophobic unit having a Mn of 9,500 obtained in Synthesis Example 3, 1.5 g (6.9 mmol) of 4-chlorobenzophenone, 6.71 g (10.3 mmol) of bis(triphenylphosphine) nickel dichloride, 1.54 g (10.3 mmol) of sodium iodide, 35.9 g (137 mmol) of triphenylphosphine and 53.7 g (821 mmol) of zinc, and the air in the flask was replaced by dry nitrogen.

To the flask was added 430 mL of N,N-dimethylacetamide (DMAc) and stirring was continued for 3 hr while the reaction temperature was maintained at 80° C., and thereafter the mixture was diluted by adding 730 mL of DMAc, followed by filtering off insoluble materials.

The obtained solution was placed in a 2-L three-necked flask equipped with a stirrer, a thermometer and a nitrogen inlet tube, and heated to 115° C. with stirring, followed by adding 44 g (506 mmol) of lithium bromide. After stirring 7 hr, the mixture was poured into 5 L of acetone to precipitate the product. The precipitate was washed sequentially with 1N hydrochloric acid and purified water, followed by drying to obtain 122 g of the desired polymer. The obtained polymer had a weight average molecular weight (Mw) of 80,000. It was presumed that the obtained polymer was a sulfonated polymer represented by formula (II).

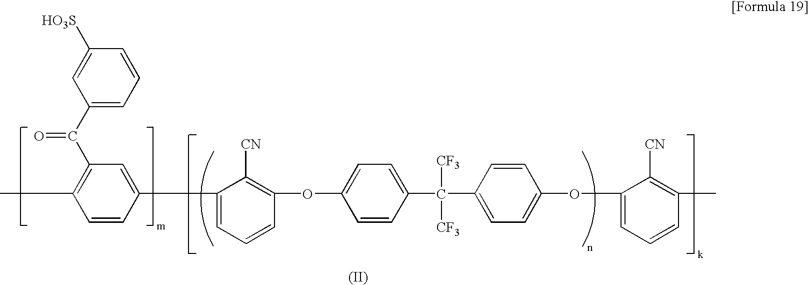

### Example 1

First, the sulfonic acid group-containing polyarylene synthesized in Synthetic Example 2 was dissolved in N-methyl-2-pyrrolidone and a polymer electrolyte membrane having a dried thickness of 40 μm was prepared by a casting method. The polymer electrolyte membrane had a proton conductivity of 4.0×10⁻¹ S/cm as measured at a temperature of 25° C. under a relative humidity of 100%.

Next, an electrode paste was prepared by homogeneously mixing particles of ruthenium dioxide hydrate (supplied by Aldrich Chemical Company Inc.) and an ion-conducting polymer binder obtained by dissolving the sulfonic acid group-containing polyarylene synthesized in Synthesis Example 2 in N-methyl-2-pyrrolidone at a weight ratio of 1:0.15 (particle: binder).

Subsequently, the electrode paste was applied to a titanium foil having a thickness of 15 μm using a blade coater so that the amount of the ruthenium dioxide hydrate was 5 mg/cm², and the applied paste was dried at 60° C. for 10 min and then under vacuum at 100° C. to form an electrode-collector assembly comprising a ruthenium dioxide hydrate layer.

Thereafter, from a circular specimen having a diameter of 14 mm was punched out the polymer electrolyte membrane, and this specimen was immersed in purified water at 50° C. for 30 min to hydrate. From the electrode-collector assembly, two circular specimens each having a 12 mm diameter were punched out, one for the positive electrode and one for the negative electrode, and immersed in purified water at 25° C. for 30 min to hydrate.

After the hydration treatment, these materials were wrapped with Teflon (R) film in a state in which the polymer electrolyte membrane was sandwiched by the electrode-collector assembly for the positive electrode and that for the negative electrode, and pressed under conditions of 170° C. and 10 kg/cm² to obtain a structure in which the electrolyte membrane/electrode interfaces were bonded. This structure was immersed in purified water at 25° C. for 15 min to hydrate. After the hydration treatment, excess moisture was removed from the surface of the structure, and the structure was set in a sealing can made of SUS as shown in FIG. 1 and sealed using a caulking apparatus to obtain an electrochemical capacitor.

Impedance was evaluated as the performance of the electrochemical capacitor. A chemical impedance measurement system manufactured by NF Corporation was used as an impedance analyzer. The impedance in the range of 1 Hz to 20 kHz was measured at a voltage of 10 mV, and the direct current component of the impedance at 1 kHz was determined as the impedance of the capacitor.

In order to determine the output capability of the capacitor, by using a Model CDT5R2-4 instrument manufactured by Power Systems Co., Ltd., charging and discharging were performed between 0 and 1 V at current densities of 2 mA/cm², 5 mA/cm², 10 mA/cm², 20 mA/cm², 50 mA/cm², 100 mA/cm² and 200 mA/cm², respectively. The charging was performed for a predetermined time (2 mA/cm²; 1500 sec, 5 mA/cm²; 600 sec, 10 mA/cm²; 300 sec, 20 mA/cm²; 150 sec, 50 mA/cm²; 60 sec, 100 mA/cm²; 30 sec or 200 mA/cm²; 20 sec), and the discharging was performed at a constant current to evaluate the discharge capacity and discharge output.

The discharge capacity was determined by an energy conversion method, and the discharge output was also calculated from this value.

Note that the discharge capacity (F/g) and discharge output (W/kg) per unit weight are values divided by the weight of the electrode material (ruthenium oxide hydrate) in both the positive and negative electrodes. Particularly the discharge capacity may be represented as a capacity with respect to the weight of a single electrode, and this notation gives a value multiplied by 4.

### Example 2

First, the sulfonic acid group-containing polyarylene synthesized in Synthesis Example 4 was dissolved in N-methyl-2-pyrrolidone, and a polymer electrolyte membrane having a dried thickness of 40 μm was prepared from this solution by a casting method.

Next, an electrode paste was prepared by homogeneously mixing particles of ruthenium dioxide hydrate (supplied by Aldrich Chemical Company Inc.) and an ion-conducting polymer binder obtained by dissolving the sulfonic acid group-containing polyarylene synthesized in Synthesis Example b in N-methyl-2-pyrrolidone at a weight ratio of 1:0.025 (particle: binder).

Subsequently, the electrode paste was applied to a stainless-steel foil having a thickness of 15 μm using a blade coater so that the amount of the ruthenium dioxide hydrate is 5 mg/cm², and the applied paste was dried at 60° C. for 10 min and then under vacuum at 100° C. to form an electrode-collector assembly comprising a ruthenium dioxide hydrate layer.

Thereafter, from the polymer electrolyte membrane, a circular specimen having a diameter of 14 mm was punched out, and this specimen was immersed in purified water at 50° C. for 30 min to hydrate. Also from the electrode-collector assembly, two circular specimens each having a diameter of 12 mm were punched out, one for the positive electrode and one for the negative electrode, and the specimens were immersed in purified water at 25° C. for 30 min to hydrate.

After the hydration treatment, these materials were wrapped with a Teflon (R) film in a state in which the polymer electrolyte membrane was sandwiched by the electrode-collector assembly for the positive electrode and that for the negative electrode, and pressed under conditions of 170° C. and 10 kg/cm² to obtain a structure in which the electrolyte membrane-electrode interfaces are bonded. This structure was immersed in purified water at 25° C. for 15 min to hydrate. After the hydration treatment, the excess moisture was removed from the surface of the structure, and the structure was set in a sealing can made of SUS as shown in FIG. 1 and sealed using a caulking apparatus to obtain an electrochemical capacitor.

The obtained electrochemical capacitor was evaluated in the same manner as Example 1.

### Example 3

In the same manner as Example 2 except that the electrode paste was prepared by homogeneously mixing particles of ruthenium dioxide hydrate (supplied by Aldrich Chemical Company Inc.) and an ion-conducting polymer binder obtained by dissolving the sulfonic acid group-containing polyarylene synthesized in Synthesis Example 5 in N-methyl-2-pyrrolidone at a weight ratio of 1:0.075 (particle: binder), an electrode-collector assembly comprising a ruthenium dioxide hydrate layer was formed, and thereafter an electrochemical capacitor was prepared and evaluated.

### Example 4

In the same manner as Example 2 except that the electrode paste was prepared by homogeneously mixing particles of ruthenium dioxide hydrate (supplied by Aldrich Chemical Company Inc.) and an ion-conducting polymer binder obtained by dissolving the sulfonic acid group-containing polyarylene synthesized in Synthesis Example 5 in N-methyl-2-pyrrolidone at a weight ratio of 1:0.15 (particle: binder), an electrode-collector assembly comprising a ruthenium dioxide hydrate layer was formed, and thereafter an electrochemical capacitor was prepared and evaluated.

### Example 5

In the same manner as Example 2 except that the electrode paste was prepared by uniformly mixing particles of ruthenium dioxide hydrate (supplied by Aldrich Chemical Company Inc.) and an ion-conducting polymer binder obtained by dissolving the sulfonic acid group-containing polyarylene synthesized in Synthesis Example 5 in N-methyl-2-pyrrolidone at a weight ratio of 1:0.30 (particle: binder), an electrode-collector assembly comprising a ruthenium dioxide hydrate layer was formed, and thereafter an electrochemical capacitor was prepared and evaluated.

### Example 6

In the same manner as Example 2 except that the electrode paste was prepared by uniformly mixing particles of ruthenium dioxide hydrate (supplied by Aldrich Chemical Company Inc.) and an ion-conducting polymer binder which was obtained by dissolving the sulfonic acid group-containing polyarylene synthesized in Synthesis Example 5 in N-methyl-2-pyrrolidone at a weight ratio of 1:0.50 (particle: binder), an electrode-collector assembly comprising a ruthenium dioxide hydrate layer was formed, and thereafter an electrochemical capacitor was prepared and evaluated.

### Comparative Example 1

In the same manner as Example 5 except that a perfluoroalkylenesulfonic acid polymer was used as the ion-conducting binder, an electrochemical capacitor was constructed and evaluation was performed in the same manner.

### Comparative Example 2

In the same manner as Example 6 except that a perfluoroalkylenesulfonic acid polymer was used as the ion-conducting binder, an electrochemical capacitor was constructed and evaluation was performed in the same manner.

TABLE 1

| Charge and discharge current | Impedance(mΩ) |
|---|---|
| Example 1 | 200 |
| Example 2 | 160 |
| Example 3 | 150 |
| Example 4 | 190 |
| Example 5 | 220 |
| Example 6 | 240 |

Evaluation was impossible for Comparative Examples 1 and 2.

TABLE 2

| | Charge and discharge current | | | | | | | |
|---|---|---|---|---|---|---|---|---|
| | 2 mA/cm² | | 5 mA/cm² | | 10 mA/cm² | | 20 mA/cm² | |
| | Capacity | Output | Capacity | Output | Capacity | Output | Capacity | Output |
| | (F/g) | (W/kg) | (F/g) | (W/kg) | (F/g) | (W/kg) | (F/g) | (W/kg) |
| Example 1 | 174 | 98 | 174 | 244 | 172 | 482 | 171 | 958 |
| Example 2 | 180 | 101 | 180 | 253 | 180 | 506 | 180 | 1010 |
| Example 3 | 182 | 102 | 182 | 256 | 181 | 509 | 180.5 | 1015 |
| Example 4 | 176 | 99 | 176 | 248 | 175 | 493 | 174 | 980 |
| Example 5 | 175 | 98 | 174 | 245 | 172 | 484 | 169 | 950 |
| Example 6 | 174 | 98 | 173 | 244 | 170 | 480 | 166 | 935 |

| | |
|---|---|
| Comparative | * 1 |
| Example 1 | |
| Comparative | * 2 |
| Example 2 | |

* 1; No evaluation was made because the membrane was peeled off during drying after the paste is applied to a Ti foil. Void bubbles were frequently observed in the dried product.
* 2; No evaluation was made because the membrane was peeled off during drying after the paste is applied to a Ti foil.

TABLE 3

| | Charge and discharge current | | | | | |
|---|---|---|---|---|---|---|
| | 50 mA/cm² | | 100 mA/cm² | | 200 mA/cm² | |
| | Capac- | | Capac- | | Capac- | |
| | ity | Output | ity | Output | ity | Output |
| | (F/g) | (W/kg) | (F/g) | (W/kg) | (F/g) | (W/kg) |
| Example 1 | 169 | 2370 | 167 | 4680 | 165 | 9200 |
| Example 2 | 179 | 2500 | 178 | 4970 | 175 | 9740 |
| Example 3 | 180 | 2530 | 179 | 5030 | 178 | 10000 |
| Example 4 | 173 | 2430 | 170 | 4770 | 167 | 9340 |
| Example 5 | 165 | 2320 | 161 | 4520 | 156 | 8760 |
| Example 6 | 160 | 2250 | 152 | 4280 | 146 | 8220 |

Evaluation was impossible for Comparative Examples 1 and 2.

1. An electrochemical capacitor having a membrane-electrode-collector structure equipped with
a pair of electrode layers containing a metal oxide and a proton-conducting polymer bonding agent, the electrode layer being connected to a metal foil collector and
a polymer electrolyte membrane sandwiched by both the electrode layers,
wherein both or either of the proton-conducting polymer bonding agent and the polymer electrolyte membrane is(are) a sulfonic acid group-containing polyarylene containing a structural unit represented by general formula (A): 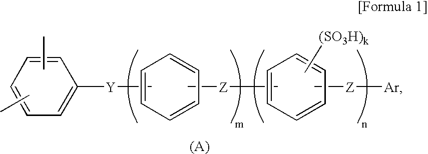
wherein Y represents at least one kind of structure selected from the group consisting of —CO—, —SO₂—, —SO—, —CONH—, —COO—, —(CF₂)₁—, wherein 1 is an integer from 1 to 10, and —C(CF₃)₂—; Z represents a direct bond or at least one kind of structure selected from the group consisting of —(CH₂)—, wherein 1 is an integer from 1 to 10, —C(CH₃)₂—, —O— and —S—; Ar represents an aromatic group having a substituent represented by —SO₃H, —O(CH₂)ₚSO₃H or —(CF₂)ₚSO₃H; p represents an integer from 1 to 12; m represents an integer from 0 to 10; n represents an integer from 0 to 10; and k represents an integer from 1 to 4; and a structural unit represented by general formula (B): 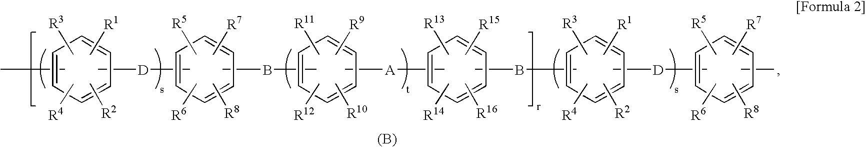
wherein A and D independently represent a direct bond or at least one kind of structure selected from the group consisting of —CO—, —SO₂—, —SO—, —CONH—, —COO—, —(CF₂)₁—, wherein 1 is an integer from 1 to 10, —C(CH₂)₁—, wherein 1 is an integer from 1 to 10, —CR′₂—, wherein R′ represents an aliphatic hydrocarbon group, an aromatic hydrocarbon group or a halogenated hydrocarbon group, a cyclohexylidene group, a fluorenylidene group, —O— and —S—; B is independently an oxygen atom or a sulfur atom; R¹ to R¹⁶ may be the same or different from each other and each represents at least one kind of atom or group selected from the group consisting of a hydrogen atom, a fluorine atom, an alkyl group, a haloalkyl group, which is partially or fully halogenated, an allyl group, an aryl group, a nitro group and a cyano group; s and t represent an integer from 0 to 4; and r represents 0 or an integer of 1 or more.

2. The electrochemical capacitor according to claim 1, wherein the metal foil collector is made of titanium or stainless steel having a thickness of 10 to 100 μm.

3. The electrochemical capacitor according to claim 1, wherein, in the metal oxide and the proton-conducting bonding agent, the amount of the proton-conducting bonding agent is 2.5 parts by weight or more and 50 parts by weight or less with respect to 100 parts by weight of the metal oxide.

4. The electrochemical capacitor according to any of claims 1 to 3, wherein the sulfonic acid group-containing polyarylene contains sulfonic acid groups in the range of 0.3 to 5 meq/g.
